(19) United States
(12) Patent Application Publication
(10) Pub. No.: US 2013/0147982 A1
(43) Pub. Date: Jun. 13, 2013

(54) IMAGING METHOD AND APPARATUS

(71) Applicant: Samsung Electronics Co., Ltd., Gyeonggi-do (KR)

(72) Inventor: Masatsugu HIRAYAMA, Kanagawa (JP)

(73) Assignee: Samsung Electronics Co., Ltd., Gyeonggi-do (KR)

(21) Appl. No.: 13/685,021

(22) Filed: Nov. 26, 2012

(30) Foreign Application Priority Data
Nov. 24, 2011 (JP) 2011-256404

(51) Int. Cl. H04N 5/225

(52) U.S. Cl. CPC H04N 5/225
USPC 348/222.1

(57) ABSTRACT

Provided are an imaging apparatus, an imaging method, and an image processing apparatus in which generation of an omni-focal image is possible without based on a position in a depth direction in a process of acquiring a captured image. To this end, the imaging apparatus includes an imaging unit for capturing a sweep image by continuous exposing a focus lens or an imaging element during driving of the focus lens or the imaging element in an optical-axis direction and an image processor for deconvolutioning the captured sweep image to generate a deconvolution image.

### PRIORITY

This patent application claims priority under 35 U.S.C. §119(a) to Japanese Patent Application Serial No. JP 2011-256404, which was filed in the Japanese Intellectual Property Office on Nov. 24, 2011, the content of which is incorporated herein by reference.

### BACKGROUND OF THE INVENTION

1. Field of the Invention

The present invention generally relates to an imaging apparatus, and more particularly, to an imaging method and apparatus which provides an accurate-focused image.

2. Description of the Related Art

A digital still camera having an Auto Focus (AF) function adjusts a focus after a shutter button is pressed, and performs capturing of a focused image. Conventionally, a method has been proposed in which capturing of an image is performed between pressing of a shutter button and capturing of a focused image, and the captured image is used as a not-yet-focused image for a high display quality technique.

As image processing methods using a focused image and a not-yet-focused image, for example, a method for correcting a not-yet-focused image by additionally using a focused image and a method for correcting a focused image by additionally using a not-yet-focused image have been proposed.

A technique disclosed in a Japanese Patent Application Publication Gazette No. 2011-044839 and a technique disclosed in a Japanese Patent Application Publication Gazette No. 2011-109619 are examples of the method for correcting the not-yet-focused image by additionally using the focused image.

The Japanese Patent Application Publication Gazette No. 2011-044839 discloses a method for detecting motion between a not-yet-focused image which is an image before focusing and a focused image which is an image in focusing, generating a motion-compensation image corresponding to the not-yet-focused image, and correcting blur of the not-yet-focused image based on the corresponding motion-compensation image and the not-yet-focused image.

The Japanese Patent Application Publication Gazette No. 2011-109619 discloses a method for obtaining a plurality of captured images according to a plurality of exposure patterns during an exposure period and applying a function, which is generated based on the amount of vibration, detected in a captured image and an exposure pattern, to the captured image, thereby generating and synthesizing a plurality of corrected images.

As an example of the method for correcting a focused image by additionally using a not-yet-focused image, a method for reflecting a feature obtained in image data acquired before focusing as a parameter or processing an image after developed has been disclosed.

For example, a Japanese Patent Application Publication Gazette No. 2005-197885 discloses a method for detecting a position of the pupil of the eye by using image data obtained prior to focusing during distance measurement, and performing red-eye correction based on the corresponding detection result in post-processing.

When the technique disclosed in the Japanese Patent Application Publication Gazette No. 2011-044839 is used, blur resulting from motion of an object may be surely improved. However, for blur depending on a depth direction, due to the use of the repetitive method, the real-time property of image acquisition is not provided.

When the technique disclosed in the Japanese Patent Application Publication Gazette No. 2011-109619 is used, the quality improvement of the not-yet-focused image may be surely guaranteed. However, since vibration correction is performed after image capturing in necessary all exposure conditions, high calculation cost is required.

The technique disclosed in the Japanese Patent Application Publication Gazette No, 2005-197885 detects the position of the pupil of the eye prior to focusing. However, although the image obtained during AF by the method proposed in this gazette guarantees a contrast of a predetermined level or higher, it is out of focus when compared to captured data after focusing and application for high display quality such as noise reduction and sharpness is difficult to achieve.

### SUMMARY OF THE INVENTION

Accordingly, the present invention provides an imaging method and apparatus in which generation of a deconvolution image, which is an omni-focal image, is possible without based on a position in a depth direction in a process of acquiring a captured image.

According to an aspect of the present invention, there is provided an imaging apparatus including an imaging unit for capturing a sweep image by continuous exposing a focus lens or an imaging element during driving of the focus lens or the imaging element in an optical-axis direction and an image processor for deconvolutioning the captured sweep image to generate a deconvolution image.

According to another aspect of the present invention, there is provided an imaging method of an imaging apparatus, the imaging method including an imaging step of capturing a sweep image by continuous exposing a focus lens or an imaging element during driving of the focus lens or the imaging element in an optical-axis direction, and an image processing step of generating a deconvolution image by deconvolutioning the captured sweep image.

According to another aspect of the present invention, there is provided an image processing apparatus including an image acquiring unit for acquiring a sweep image acquired through capturing by continuous exposing a focus lens or an imaging element during driving of the focus lens or the imaging element in an optical-axis direction and an image processor for deconvolutioning the captured sweep image and generating a deconvolution image.

### BRIEF DESCRIPTION OF THE DRAWINGS

The above and other features and advantages of exemplary embodiments of the present invention will be more apparent from the following detailed description taken in conjunction with the accompanying drawings, in which:

FIG. 1 is a diagram illustrating a structure of an imaging apparatus according to a first embodiment of the present invention;

FIG. 2 is a diagram illustrating a process of acquiring a sweep image according to a first embodiment of the present invention;

FIG. 3 is a flowchart illustrating a process of acquiring a sweep image and a focused image according to a first embodiment of the present invention;

FIG. 4 is a diagram illustrating a structure of an image processor of an imaging apparatus according to a second embodiment of the present invention;

FIG. 5 is a diagram illustrating a structure of an image processor of an imaging apparatus according to a third embodiment of the present invention;

FIG. 6 is a diagram illustrating a structure of an image processor of an imaging apparatus according to a third embodiment of the present invention; and

FIG. 7 is a flowchart illustrating a process of displaying an image selection screen according to a fourth embodiment of the present invention.

### DETAILED DESCRIPTION OF EMBODIMENTS OF THE INVENTION

Hereinafter, exemplary embodiments of the present invention will be described in detail with reference to the accompanying drawings. In the specification and drawings, components having substantially identical functional structures will be referred to as identical reference numerals and will not be repetitively described.

An imaging apparatus according to the present invention may include an imaging unit for capturing a sweep image by continuously exposing as focus lens or an imaging element during driving of the focus lens or the imaging element in an optical-axis direction and an image processor for generating a deconvolution image by deconvolutioning the captured sweep image.

The sweep image is not affected by a position in a depth direction of an object. The image processor, by deconvolutioning the sweep image, generates a reconstruction image from which blur of the entire region of the image is removed. The sweep image is also captured during driving of the focus lens or the imaging element for capturing a focused image, such that a time for capturing the sweep image after capturing of the focused image is not necessary. As a result, in the process of acquiring the captured image, the deconvolution image, which is an omni-focal image, may be generated without based on the position in the depth direction.

The imaging unit captures the focused image after focusing of the focus lens. The image processor includes a first High-Pass Filter (HPF) for passing high-frequency components of the focused image, a second HPF for passing high-frequency components of the deconvolution image, and a focused region determiner for determining a focused region in the focused image based on the focused image and the deconvolution image.

By passing the focused image and the deconvolution image through the first and second HPFs, the focused region composed of high-frequency components is detected. By determining the focused region from both the focused image and the deconvolution image, even if the focused region is erroneously determined from the focused image, accurate determination can be made. As a result, when compared to a case where the focused region is determined from only the focused image after passing through the HPFs, the precision of detection of the focused region is improved.

The image processor separately performs image processing in the focused region and a non-focused region of the detected focused image.

Based on the foregoing structure, if the purpose of image processing on the focused region and the purpose of image processing on the non-focused region are different, different image processing may be performed. Consequently, image processing may be performed suitably for the purpose of each region of the image.

The imaging apparatus may further include a display for displaying the deconvolution image and the focused image and a manipulation unit for selecting the deconvolution image or the focused image.

With this structure, a user may select a desired image from the deconvolution image and the focused image displayed on the display. As a result, the convenience of the imaging apparatus may be improved.

The image processor synthesizes the focused image and the sweep image in the region other than the focused region.

The sweep image is an image captured during driving of the focus lens or the imaging element in the optical-axis direction, and includes blur in the optical-axis direction. By synthesizing the sweep image in the non-focused region of the focused image, the non-focused region of the focused image is largely blurred. As a result, the focused region including an object such as a person may be emphasized.

An imaging method according to the present invention includes an imaging step of capturing a sweep image by continuous exposing a focus lens or an imaging element during driving of the focus lens or the imaging element in an optical-axis direction and an image processing step of generating a deconvolution image by deconvolutioning the captured sweep image.

An image processing apparatus according to the present invention includes an image acquiring unit for acquiring a sweep image acquired through capturing by continuous exposing a focus lens or an imaging element during driving of the focus lens or the imaging element in an optical-axis direction and an image processor for deconvolutioning the captured sweep image and generating a deconvolution image.

The description will be made in the following order:

1. First Embodiment

1-1. Entire Structure of Imaging Apparatus 10

1-2. Flow of Capturing Processing and Deconvolution Processing According to First Embodiment

2. Second Embodiment

3. Third Embodiment

4. Fourth Embodiment

### 1. First Embodiment

### 1-1. Entire Structure of Imaging Apparatus 10

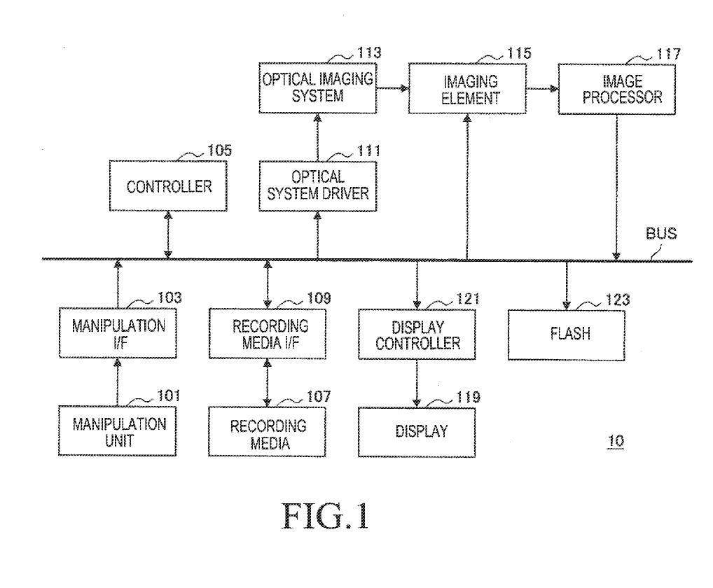

First, the structure of the imaging apparatus 10 according to the current embodiment will be described with reference to FIG. 1. FIG. 1 is a diagram illustrating an example of the structure of the imaging apparatus 10 according to the current embodiment of the present invention. The structure shown in FIG. 1 is merely an example, and some components may be omitted, added or changed. The imaging apparatus 10 may be, for example, a digital still camera capable of capturing a still image or a portable phone, a game player, an information terminal or a Personal Computer (PC) having mounted thereon an imaging function equivalent to the digital still camera.

The imaging apparatus 10, as shown in FIG. 1, may include a manipulation unit 101, a manipulation interface (I/F) 103, a controller 105, a recording media 107, a recording media I/F 109, an optical system driver 111, an optical imaging system 113, an imaging element 115, an image processor 117, a display 119, a display controller 121, and a flash 123.

Manipulation performed by a user with respect to the manipulation unit 101 is input to each unit of the imaging apparatus 10 through the manipulation I/F 103. The manipulation unit 101 may include a power button, up/down/left/right keys, a mode dial, a shutter button, and so forth.

The controller 105 controls processing performed by each unit of the imaging apparatus 10 according to an input of the manipulation unit 101. The function of the controller 105 is implemented with, for example, a Central Processor Unit (CPU).

For example, if the user half-presses the shutter button, focus control of the controller 105 is initiated; if the user releases the half-pressing, the focus control is ended. For example, if the user fully presses the shutter button, capturing is initiated.

The image captured in the imaging apparatus 10 is stored in the recording media 107 through the recording media I/F 109. The recording media 107 may be an external memory device such as a memory card.

The optical system driver 111 drives the optical imaging system 113 based on a control signal of the controller 105. For example, the optical imaging system 113 may include a lens 131, an iris, and so forth, and the optical system driver 111 may be a motor installed in the lens 131, the iris, or the like. In the current embodiment, the lens 131 is mainly a focus lens. The focus lens moves in the optical-axis direction, and focuses an object image on an imaging surface 115A of the imaging element 115 described below. The imaging apparatus 10 detects a distance to the object and a focus position and has an AF function of automatically adjusting the focus of the lens 131.

The imaging element 115 includes a plurality of photoelectric conversion elements for converting light incident after passing through the lens 131 into an electric signal. Each photoelectric conversion element generates an electric signal based on the quantity of received light. The imaging element 115 available may be, for example, a Charge Coupled Device (CCD) image sensor or a Complementary Metal Oxide Semiconductor (CMOS) image sensor. The imaging surface 115A of the imaging element 115 is a surface into which light passing through the lens 131 is incident. Once the optical signal is converted into an electric signal, the imaging element 115 outputs the electric signal to the image processor 117.

The image processor 117 performs various image processing with respect to the captured image. For example, as will be described below, in the current embodiment, the captured sweep image is deconvolutioned; in a second embodiment of the present invention, noise cancellation is performed with respect to the captured focused image. The image output from the image processor 117 is recorded in the recording media 107 through the recording media I/F 109 or is displayed on the display 119 through the display controller 121.

The imaging apparatus 10 may perform photographing in a dark condition through light-emission of the flash 123.

So far, the entire structure of the imaging apparatus 10 has been described.

### 1-2. Flow of Capturing Processing and Deconvolution Processing According to First Embodiment

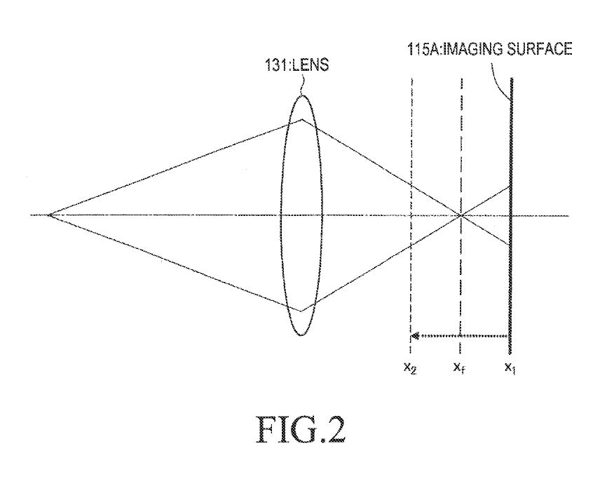

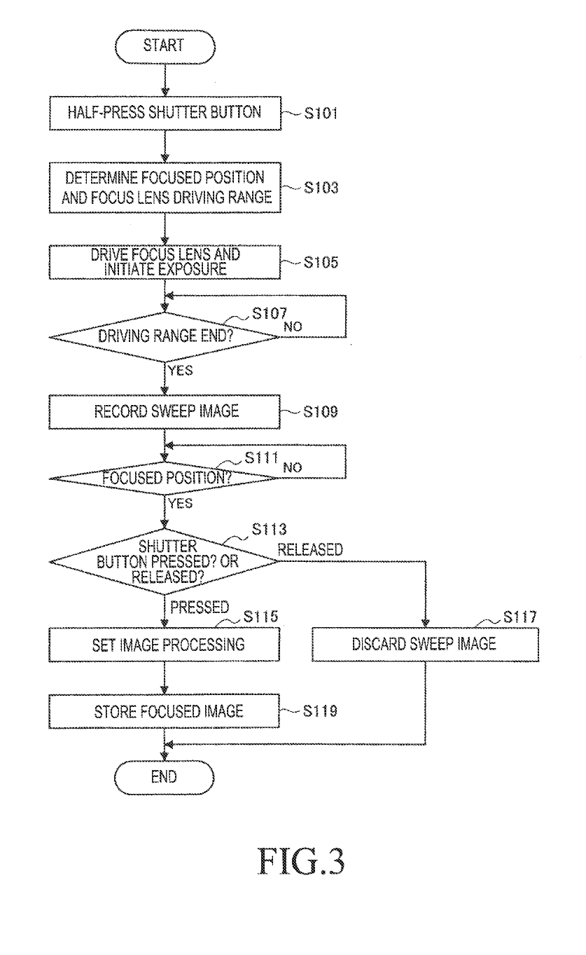

With reference to FIGS. 2 and 3, a description will now be made of deconvolution image generation of the imaging apparatus 10 according to the current embodiment.

As shown in FIG. 2, the imaging apparatus 10 acquires a sweep image which is an image captured by exposing the lens 131 or the imaging element 115 continuously for a predetermined time during driving of the lens 131 or the imaging element 115 in an optical-axis direction, that is, in a depth direction of an object.

In practice, either the lens 131 or the imaging element 115 may be driven, but in the following description, for convenience's sake, the position of the imaging surface 115A of the imaging element 115 on the optical axis with respect to the position-fixed lens 131 is assumed to be x. The driving range of the imaging surface 115A is set to include a predetermined section from a section extending ahead and behind a focused position (x=xf), including the focused position.

For example, continuous exposure is performed while moving the imaging surface 115A from a position x1 of a back-focusing state to a position x2 of a front-focusing state corresponding to the position x1, thereby acquiring the sweep image. Herein, the front-focusing state refers to a case where a focused surface with respect to the imaging surface 115A is in the side of the lens 131, and the back-focusing state refers to a case where a focused surface with respect to the imaging surface 115A is in the opposite side to the lens 131.

The driving range may be a section of the front-focusing state or a section of the back-focusing state which does not include the focused position.

FIG. 3 is a flowchart illustrating a process of acquiring a sweep image and a focused image according to a first embodiment of the present invention. Imaging processing described below is implemented by the controller 105, the optical system driver 111, and the optical imaging system 113 of the imaging apparatus 10. The following description will be made of a flow corresponding to a case where the sweep image is captured in the section of the front-focusing state or the section of the back-focusing state.

As shown in FIG. 3, if the user half-presses the shutter button of the manipulation unit 101 in step S101, the controller 105 of the imaging apparatus 10 determines the focused position and the focus lens driving range in step S103.

The controller 105 then performs control for driving the lens 131 in the determined focus lens driving range and performs exposure control of the imaging element 115. The optical system driver 111 initiates driving of the lens 131 of the optical imaging system 113 based on control of the controller 105. The optical system driver 111 initiates exposure of the imaging element 115 which is to be continuously performed during driving of the lens 131 in step S105.

The controller 105 then waits for end of driving of the focus lens in the focus lens driving range in step S107, and goes to step S109.

The controller 105 performs control for recording the sweep image exposed in the focus lens driving range in the recording media 107 of the imaging apparatus 10 in step 109.

The controller 105 determines whether the imaging element 115 is in a focused position in step S111. The controller 105 waits until the imaging element 115 arrives at the focused position in step S111, and goes to step S113.

In step S113, the controller 105 determines whether the shutter button of the manipulation unit 101 is pressed or released. If the shutter button is pressed, the controller 105 goes to step S115. If the shutter button is released, the controller 105 goes to step S117.

In step S115, the controller 105 performs image processing setting such as white balance adjustment or switch of an imaging mode. The controller 105 then captures the focused image and stores the captured focused image in the recording media 107, and then terminates processing in step S119.

In step S117, the controller 105 discards the sweep image recorded in step S109 and terminates processing.

So far, an example of a flow of the imaging method for the sweep image and the focused image has been simply described. According to another embodiment, some processing may be changed. For example, in step S101, manipulation other than half-pressing of the shutter button may be performed as long as it is manipulation for providing the AF function of the imaging apparatus 10.

For example, if the sweep image is captured by performing exposure while moving the imaging surface 115A from the position x1 of the back-focusing state to a position x2 of a front-focusing state corresponding to the position x1, the controller 105 performs control for driving the imaging element 115 in a reverse direction to the optical-axis direction of the step S109, between steps S109 and S111. The optical system driver 111 drives the imaging element 115 based on control of the controller 105.

As described before, the sweep image, because of being captured before focusing, is an out-of-focus image. The image captured as the sweep image is an image in which a Point Spread Function (PSF) indicating a blur state of an original image and points is convolutioned. Therefore, through deconvolutioning, the non-blur original image is reconstructed from the sweep image.

Herein, the PSF of the sweep image corresponding to a case where the imaging element 115 is driven from the position x=x1 to the position x=x2, that is, h may be expressed as follows:

h=∫₁²PSF(x)dx (1),

wherein the function PSF(x) indicates a PSF corresponding to a case where the imaging surface 115A of the imaging element 115 is at the position x on the optical axis with respect to the position of the focus lens 131.

By using a Wiener filter given in Equation 2, the reconstruction image is obtained. F, F′, and H indicate a swep image, a reconstruction image and Fourier transformation of h which is the PSF of the sweep image given by Equation 1. Γ is a constant.

$$\hat{F} = \frac{F \cdot \overline{H}}{\vert {H}^{2} \vert + Γ} \qquad ( 2 )$$

For |H²|, Equation 3 is established.

|H²|=H· H̅ (3)

The acquired reconstruction image (the deconvolution image, for short) is an omni-focal image which is in focus, that is, has little blur, over the entire region of the image. Herein, generally, PSF is a function regarding the position x of the imaging surface 115A on the optical axis and the position of the object on the optical axis. However, the object's position on the optical axis may vary with a position (i, j) of the imaging surface 115A. However, in Equation 1, the function PSF is integrated in a predetermined driving range of the imaging element 115, such that the PSF for the sweep image may be uniformly processed within the imaging surface 115A. For this reason, with low processing load, the imaging apparatus 10 may generate a high-quality image from which blur in the depth direction is removed, without based on the position in the depth direction.

Preferably, the lens 131 or the imaging element 115 is driven at a constant speed during capturing of the sweep image or the sweep image is captured during a section in which the lens 131 or the imaging element 115 is driven at a constant speed.

Thus, the position x of the imaging surface 115A on the optical axis may be calculated as a linear function of time t in Equation 1, such that the processing load of the imaging apparatus 10 may be reduced.

The driving range of the imaging element 115 may be a section of a front-focusing state or a section of a back-focusing state, as mentioned before. However, to uniformly process the PSF for the sweep image within the imaging surface 115A, the driving range of the imaging element 115 is preferably from the position of the front-focusing state to the position of the back-focusing state corresponding thereto.

The imaging apparatus 10 according to the current embodiment of the present invention acquires and keeps the sweep image during focusing from the half-pressing of the shutter button to focusing, thereby reducing imaging time when compared to a case where the focused image and the sweep image are separately captured.

The flow of capturing processing and deconvolution processing according to the first embodiment has been described above.

### 2. Second Embodiment

The second embodiment relates to a method for performing image processing such as noise cancellation from the focused image, by using the deconvolution image or the sweep image generated in the first embodiment. Image processing to be described below is implemented by the image processor 117 of the imaging apparatus 10 according to the first embodiment of the present invention.

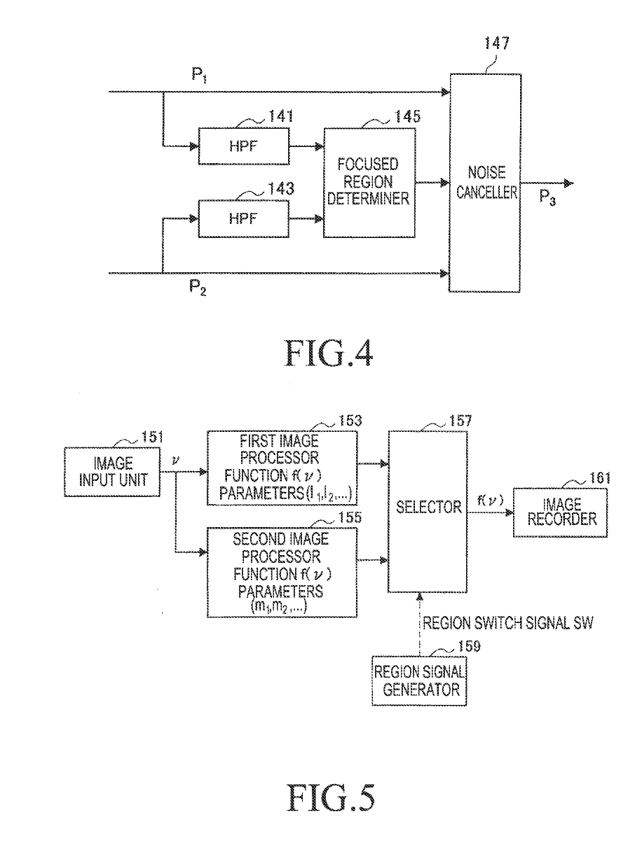

FIG. 4 is a diagram illustrating an example of the structure of the image processor 117 for performing noise cancellation by using a HPF.

The image processor 117 detects a focused region from two images and averages pixel values of corresponding pixels, respectively, thereby performing noise cancellation.

Hereinafter, noise cancellation performed by the image processor 117 will be described in detail with reference to FIG. 4.

As shown in FIG. 4, upon input of a focused image P1 and a deconvolution image P2, the input focused image P1 and deconvolution image P2 pass through an HPF 141 and an HPF 143 included in the image processor 117, and pixel values after passing through the HPFs 141 and 143 are input to the focused region determiner 145.

As the focused image P1 and the deconvolution image P2 pass through the HPF 141 and the HPF 143, a focused region including high-frequency components is detected.

Next, the focused region determiner 145 detects a region in which the HPF output of the focused image P1 and the HPF output of the deconvolution image P2 are large as a focused region (hereinafter, a focused region F). The focused region determiner 145, upon determining the focused region F, outputs the determination result to a noise canceller 147.

The focused region determiner 145 may detect a region in which either the HPF output of the focused image P1 or the HPF output of the deconvolution image P2 is large as the focused region F.

The focused region determiner 145 may also detect the focused region F from only the HPF output of the focused image P1. However, when the focused region determiner 145 detects the focused region F considering both the HPF output of the focused image P1 and the HPF output of the deconvolution image P2, detection precision may be improved.

The noise canceller 147 uses an average value of a pixel value of the focused image P1 and a pixel value of the deconvolution image P2 as in Equation 4 as a pixel value of a post-noise-cancellation image P3 in the focused region F and uses the pixel value of the focused image P1 as in Equation 5 as the pixel value of the post-noise-cancellation image P3 in a non-focused region.

$$\begin{matrix}{P}_{3} ( i , j ) = \frac{{P}_{1} ( i , j ) + {P}_{2} ( i , j )}{2} ( ( i , j ) ∈ F ) & ( 4 ) \\ {P}_{3} ( i , j ) = {P}_{1} ( i , j ) ( ( i , j ) ∉ F ) & ( 5 )\end{matrix}$$

Herein, generally, noise is randomly generated. For this reason, by composing (synthesizing) a plurality of images in a state where positions of the images are matched, noise in the images may be reduced.

As in Equation 4, in the focused region F, pixel values of corresponding pixels are averaged in a state where the positions of the focused image P1 and the deconvolution image P2 are matched, thereby generating a noise-canceled high-quality image.

In the non-focused region, pixel values of corresponding pixels are different between the focused image P1 and the deconvolution image P2, such that the pixel value of the focused image P1 is used as the pixel value of the post-noise-cancellation image P3.

In addition, the focused image P1 is composed with a plurality of deconvolution images P21, P22, P23, . . . which are generated from a plurality of sweep images obtained during driving of the lens 131 or the imaging element 115 in the optical-axis direction, thereby generating the post-noise-cancellation image P3.

By synthesizing the plurality of deconvolution images, noise cancellation may be performed more effectively.

So far, noise cancellation according to the current embodiment has been described with reference to FIG. 4. A description will now be made of a method for generating a special-effect image according to the current embodiment.

The image processor 117 detects the focused region F of a focused image identically to in the above-described noise cancellation.

The image processor 117 then synthesizes the focused image and the sweep image for the non-focused region of the focused image.

Herein, the sweep image generated in the first embodiment is an image captured during driving of the lens 131 or the imaging element 115, and blur occurs in many regions of the image.

Therefore, for the non-focused region of the focused image, the sweep image is synthesized for large blur, thereby generating a special-effect image in which the focused region including an object such as a person is emphasized.

As in noise cancellation or acquisition of the special-effect image described above, if the purpose of image processing for the focused region and the purpose of image processing for the non-focused region are different, different image processing may be performed. Thus, image processing may be performed suitably for the purpose of each region of the image.

The second embodiment has been described so far.

### 3. Third Embodiment

The third embodiment relates to a method for separately performing image processing suitable for each region in the focused region and the non-focused region of the focused image by using a determination result for the focused region F in the second embodiment. Image processing described below is implemented by the image processor 117 of the imaging apparatus 10 according to the first embodiment.

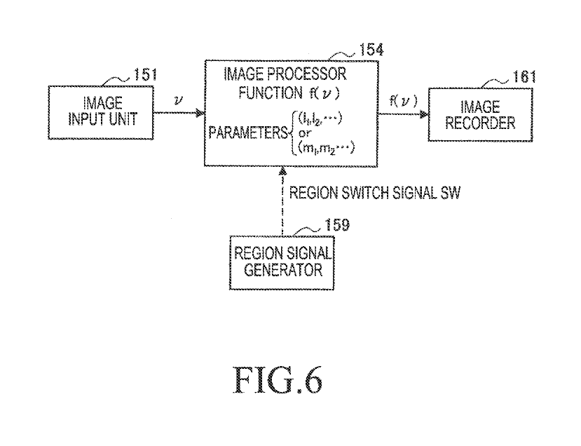

FIGs. 5 and 6 are diagrams illustrating examples of structures of the image processor 117 for separately performing image processing for the focused region and the non-focused region of the focused image. Hereinafter, image processing performed by the image processor 117 will be described in detail.

First, an example of image processing shown in FIG. 5 will be described.

An image input unit 151 outputs a pixel value v of a pixel sequentially selected from pixels forming a focused image to a first image processor 153 and a second image processor 155.

Upon input of the pixel value v, the first image processor 153 corrects the pixel value v based on a function ƒ(v) having parameters 11, 12, . . . for performing image processing suitable for the focused region, and outputs the corrected pixel value to a selector 157. In parallel with processing of the first image processor 153, the second image processor 155, upon input of the pixel value v, corrects the pixel value v based on a function ƒ(v) having parameters m1, m2, . . . for performing image processing suitable for the non-focused region, and outputs the corrected pixel value to the selector 157.

For example, the first image processor 153 performs image processing such as skin correction, contrast adjustment, or the like and the second image processor 155 performs processing such as strong noise reduction.

Different processing may be performed for different regions as described above, for example, a contrast may be weakened for the focused region including an object such as a person to provide a mild impression; for the non-focused region including a background, noise cancellation may be effectively performed.

A region signal generator 159 outputs, to the selector 157, a region switch signal SW indicating whether each pixel of the focused image is included in the focused region F based on the determination result for the focused region F in the second embodiment.

The selector 157 selects an input value from the first image processor 153 or an input value from the second image processor 155 according to a value of the region switch signal SW corresponding to a pixel of the focused image which is input from the region signal generator 159, and outputs the selected input value to an image recorder 161.

In this case, for example, the region signal generator 159 may output SW=1 if the input pixel is included in the focused region, and may output SW=0 if the input pixel is not included in the focused region.

For SW=1, the selector 157 regards that an important object such as a person is included, and thus selects the input value from the first image processor 153. For SW=0, the selector 157 regards that a background is included, and thus selects the input value from the second image processor 155.

An example of image processing illustrated in FIG. 5 has been described above.

Hereinafter, an example of image processing illustrated in FIG. 6 will be described. The image input unit 151 outputs a pixel value v of a pixel sequentially selected from all pixels forming a focused image to the image processor 154.

The region signal generator 159 outputs, to the image processor 154, a region switch signal SW indicating whether each pixel of the focused image is included in the focused region F based on the determination result for the focused region F in the second embodiment.

The image processor 154, upon input of the pixel value v, selects, as parameters of a function ƒ(v), either parameters 11, 12, for performing image processing suitable for the focused region or parameters m1, m2, . . . , for performing image processing suitable for the non-focused region according to the value of the region switch signal SW corresponding to the input pixel.

For example, the image processor 154 may perform image processing, such as skin correction, contrast adjustment, or the like, suitable for the focused region and may perform processing such as strong noise reduction, suitable for the non-focused region.

The parameters 11, 12, . . . , and the parameters m1, m2, . . . , may be those previously stored in the recording media 107 of the imaging apparatus 10, or may be designated by user's manipulation with respect to the manipulation unit 101.

Once performing image processing for the focused image, the image processor 154 outputs the processed image to the image recorder 161.

For example, the region signal generator 159 outputs SW=1 if the input pixel is included in the focused region, and outputs SW=0 if the input pixel is not included in the focused region. In this case, the selector 157 selects the parameters 11, 12, . . . , for SW=1, and selects the parameters m1, m2, . . . , for SW=0.

So far, an example of image processing illustrated in FIG. 6 has been described.

As described above, by using the region switch signal based on the focused image and the deconvolution image, image processing suitable for the purpose of each region of the image may be performed.

The third embodiment of the present invention has been described above.

### 4. Fourth Embodiment

The fourth embodiment relates to a method for allowing a user to select a desired image from the deconvolution image and the focused image according to the first embodiment. Image processing described below is implemented by each part of the imaging apparatus 10 according to the first embodiment.

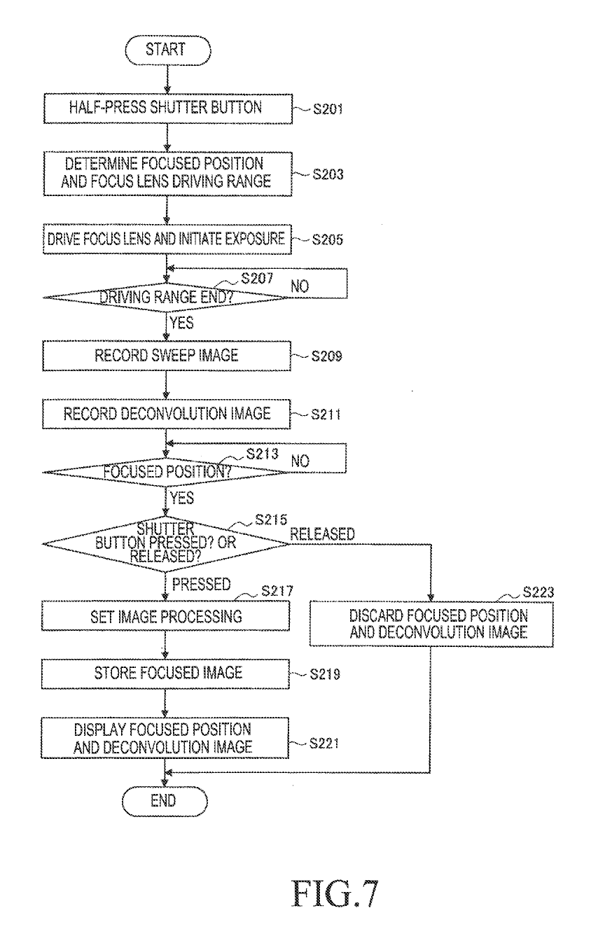

FIG. 7 is a flowchart illustrating a process of displaying an image selection screen according to the fourth embodiment of the present invention.

As shown in FIG. 7, once the user half-presses the shutter button of the manipulation unit 101 in step S201, the controller 105 of the imaging apparatus 10 determines a focused position and a driving range of a focus lens in step S203.

The controller 105 performs control for driving the focus lens within the determined focus lens driving range. The optical system driver 111 initiates driving of the focus lens of the optical imaging system 113 and at the same time, initiates exposure, based on control of the controller 105 in step S205.

Next, the controller 105 waits for end of driving of the focus lens within the focus lens driving range in step S207 and goes to step S209.

In step S209, the controller 105 outputs the sweep image exposed within the focus lens driving range to the image processor 117.

The image processor 117 generates a deconvolution image by deconvolutioning the sweep image, and records the generated deconvolution image in an internal memory or the like in step S211.

The controller 105 then determines whether the imaging element 115 is in a focused position in step S213. The controller 105 waits until the imaging element 115 arrives at the focused position, and goes to step S215.

In step S215, the controller 105 determines whether the shutter button of the manipulation unit 101 is pressed or released. If the shutter button is pressed, the controller 105 goes to step S217. If the shutter button is released, the controller 105 goes to step S223.

In step S217, the controller 105 performs image processing setting such as white balance adjustment or switch of an imaging mode. The controller 105 then captures the focused image and stores the captured focused image in the internal memory in step S219.

The display controller 121 performs control for displaying the captured focused image and the generated deconvolution image on the display 119. The user selects one of or both of the focused image and the deconvolution image by manipulating the manipulation unit 101. The user may select none of the focused image and the deconvolution image. The controller 105 records the image selected by the user in the recording media 107 and terminates processing in step S221.

In step S223, the controller 105 discards the recorded sweep image and deconvolution image and terminates processing in step S223.

So far, an example of a flow of a method for allowing the user to select a desired image from the deconvolution image and the focused image has been described in brief. Some processing may be modified. For example, in step S201, manipulation other than half-pressing of the shutter button may be performed as long as it is manipulation for providing the AF function of the imaging apparatus 10. For example, in step S221, the controller 105 may record an image which is not selected by the user in the recording media 107.

Herein, the deconvolution image is an image having little blur over its entire region. The focused image is an image in which the object is in focus. Selection from the deconvolution image and the focused image depends on the user who selects the object of the image or the image.

Therefore, the user can select a desired image from the deconvolution image and the focused image, such that convenience of the imaging apparatus can be improved.

The fourth embodiment of the present invention has been described so far.

While the embodiments of the present invention have been described with reference to the accompanying drawings, the present invention is not limited to the disclosed embodiments. It is apparent that those of ordinary skill in the art may achieve various changes or modifications within the scope of the technical spirit of the appended claims and those changes or modifications are construed as being included in the technical scope of the present invention.

What is claimed is:

1. An imaging apparatus comprising:
an imaging unit for capturing a sweep image by continuous exposing a focus lens or an imaging element during driving of the focus lens or the imaging element in an optical-axis direction; and
an image processor for deconvolutioning the captured sweep image to generate a deconvolution image.

2. The imaging apparatus of claim 1, wherein the imaging unit captures a focused image after focusing-in of a focus lens, and
the image processor comprises:
a first High Pass Filter (HPF) for passing high-frequency components of the focused image therethrough;
a second HPF for passing high-frequency components of the deconvolution image therethrough; and
a focused region determiner for determining a focused region of the focused image based on the focused image having passed through the first HPF and the deconvolution image having passed through the second HPF.

3. The imaging apparatus of claim 2, wherein the image processor performs image processing separately in the focused region and a non-focused region of the focused image.

4. The imaging apparatus of claim 2, further comprising:
a display for displaying the focused image and the deconvolution image; and
a manipulation unit for selecting the deconvolution image or the focused image.

5. The imaging apparatus of claim 3, further comprising:
a display for displaying the focused image and the deconvolution image; and
a manipulation unit for selecting the deconvolution image or the focused image.

6. The imaging apparatus of claim 2, wherein the image processor synthesizes the focused image and the sweep image in a region other than the focused region.

7. The imaging apparatus of claim 4, wherein the image processor synthesizes the focused image and the sweep image in a region other than the focused region.

8. An imaging method of an imaging apparatus, the imaging method comprising:
an imaging step of capturing a sweep image by continuous exposing a focus lens or an imaging element during driving of the focus lens or the imaging element in an optical-axis direction; and
an image processing step of generating a deconvolution image by deconvolutioning the captured sweep image.

9. An image processing apparatus comprising:
an image acquiring unit for acquiring a sweep image acquired through capturing by continuous exposing a focus lens or an imaging element during driving of the focus lens or the imaging element in an optical-axis direc; and
an image processor for deconvolutioning the captured sweep image and generating a deconvolution image.
